(19) United States
(12) Patent Application Publication
(10) Pub. No.: US 2015/0154379 A1
(43) Pub. Date: Jun. 4, 2015

(54) METHOD AND SYSTEM TO FACILITATE CARE OF A PATIENT DURING TRANSPORT

(71) Applicant: Children's Hospital & Research Center at Oakland, Oakland, CA (US)

(72) Inventors: Natalie Zora Cvijanovich, Oakland, CA (US); Heidi Rosanna Flori, San Anselmo, CA (US)

(73) Assignee: Children's Hospital & Research Center at Oakland, Oakland, CA (US)

(21) Appl. No.: 14/097,096

(22) Filed: Dec. 4, 2013

(51) Int. Cl. G06F 19/00

(52) U.S. Cl. CPC G06F 19/3481; G06F 19/322

(57) ABSTRACT

A computer system for facilitating care of a patient during transport to a care facility such as a hospital is provided. The system includes a portable tablet computer which may be used by transport staff during transport of a patient to a care facility. The tablet computer may include a patient transport module programmed to display, on the portable tablet computer, a transport care protocol which sequentially displays pages of patient care tasks which are specific to transport of a patient with a predetermined medical condition. The pages of patient care tasks may be automatically displayed within predetermined patient care time periods or assessment categories during the transport of the patient.

### BACKGROUND INFORMATION

1. Field of the Disclosure

The present invention relates to care of a patient during transport. In particular, examples of the present invention relate to a system for facilitating communication with and providing information to transport staff while transporting a patient to a care facility.

2. Background

Patients are often transported to or between care facilities such as hospitals by emergency transport services such as ambulances or helicopters. Typically, the transport staff are first responders or other persons trained in pre-hospital care. Transport staff training levels vary from EMT to nurse or paramedic with advanced training. Patients are often transported in this manner to a care facility because they are in a serious medical condition. Additionally, patients may be transported between care facilities to receive a higher or more specialized level of care.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a computer system in context of patient care during transport.

FIGS. 2 through 22 are drawings of a tablet computer used in accordance with some aspects of the present disclosure.

FIG. 23 is a schematic illustrating example components of the tablet computer.

FIG. 24 is a schematic illustrating example components of a server or computer.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The disclosure particularly describes how to facilitate communication with and exchange information with transport staff while transporting a patient to a care facility. Particularly, the present disclosure describes how a computer system may be used to provide detailed care information for a patient to transport staff and may assist the transport staff in caring for the patient.

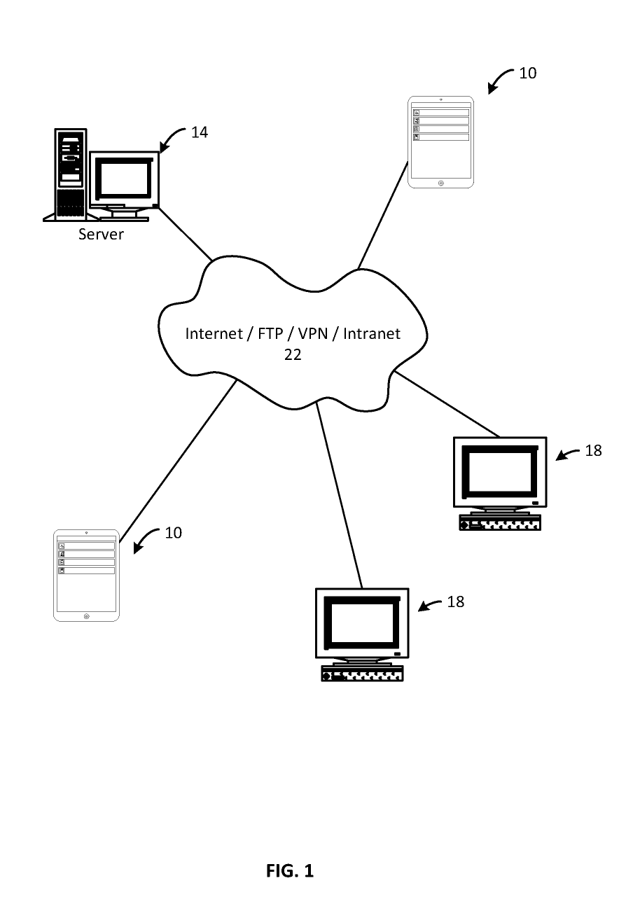

Referring to FIG. 1, a computer system may include one or more portable computing devices 10 such as tablet computers. The tablet computer 10 may communicate with other computers or devices which may include a server 14 and computers 18. The tablet computer 10, server 14, and computers 18 may communicate via the internet 22.

A tablet computer 10 may be primarily used by transport staff while transporting a patient between or to a care facility. The tablet computer 10 may facilitate communication between the transport staff and medical personnel such as a doctor who is primarily responsible for the care of the patient. The tablet computer may provide two way video conferencing between transport staff and medical personnel which is secure and encrypted to thereby allow for such communications without violating patient privacy.

The tablet computer 10 may also provide the transport staff with the ability to record patient information. The tablet computer 10 may include an electronic patient chart which allows transport staff to record patient care during transport. The tablet computer 10 may communicate with the server 14 or computer 18 to transmit encrypted information from the electronic patient chart to the secure server 14 or computer 18. In this manner, patient care may be automatically provided to the medical personnel and may be automatically added to patient records at the care facility.

The tablet computer 10 may also provide the transport staff with information necessary for the care of the patient during transport. The tablet computer 10 may include patient care protocols which are specific to the type of patient and the medical condition of the patient (i.e. illness or injury) and which are specific to transport of the patient. The patient care protocols may automatically provide transport staff with patient care instruction during transport as the need for such information arises. In this manner, the tablet computer 10 may guide the transport staff during transport to provide appropriate patient care.

The server 14 may store patient data, care information, patient care protocols, or the like and may often be located at a care facility such as a hospital. The server 14 may thus be connected to the internet via a modem, router, or the like. The computers 18 may also be located at a care facility such as a clinic or hospital and may be connected to the internet via a modem, router, etc. The computers 18 may be doctor workstations and may have access to patient records, patient information, care protocols, etc.

The tablet computers 10 may be used by medical personnel such as a doctor primarily responsible for the care of a patient. Additionally, tablet computers may be used by transport staff. The tablet computers 10 may be connected to the internet via a wireless router when such a connection is available, such as when in proximity to a care facility. The tablet computers 10 may also be connected to the internet via a cellular network to provide communications when a tablet computer 10 is not in communication range of a wireless router or the like.

The software, hardware, and associated components of a computer system may be programmed and configured to implement one or more embodiments described herein. Transport staff may communicate with a care facility server 14 via a tablet computer 10 and a network connection or internet connection 22 to receive care information from the server 14 and to provide patient information to the server 14. Particularly, the tablet computer may include patient care protocols which include patient care algorithms specific to the type and condition of the patient and specific to transport of the patient. Transport staff may communicate via a tablet computer 10 and through a network connection or the internet 22 with medical personnel who use a tablet computer 10 or computer 18.

In selected embodiments, a tablet computer 10 may operate substantially independently. Alternately, a tablet computer 10 may be one of several tablet computers 10 forming part of a larger system. For example, a tablet computer 10 may operate at a particular location or with a particular patient transport team. Other tablet computers 10 may operate in another location or with another patient transport team. The tablet computers 10 may be interconnected via a LAN, the internet, cellular network, etc. The tablet computers 10 may also be interconnected with a server 14 and computers 18.

A server 14 or computer 18 may support the operation of the tablet computer 10. For example, a server 14 or computer 18 may transmit or receive patient information from the tablet computer 10 and may transmit patient care protocol information to the tablet computer 10. A computer 18 may be used for video conferencing with the tablet computer 10.

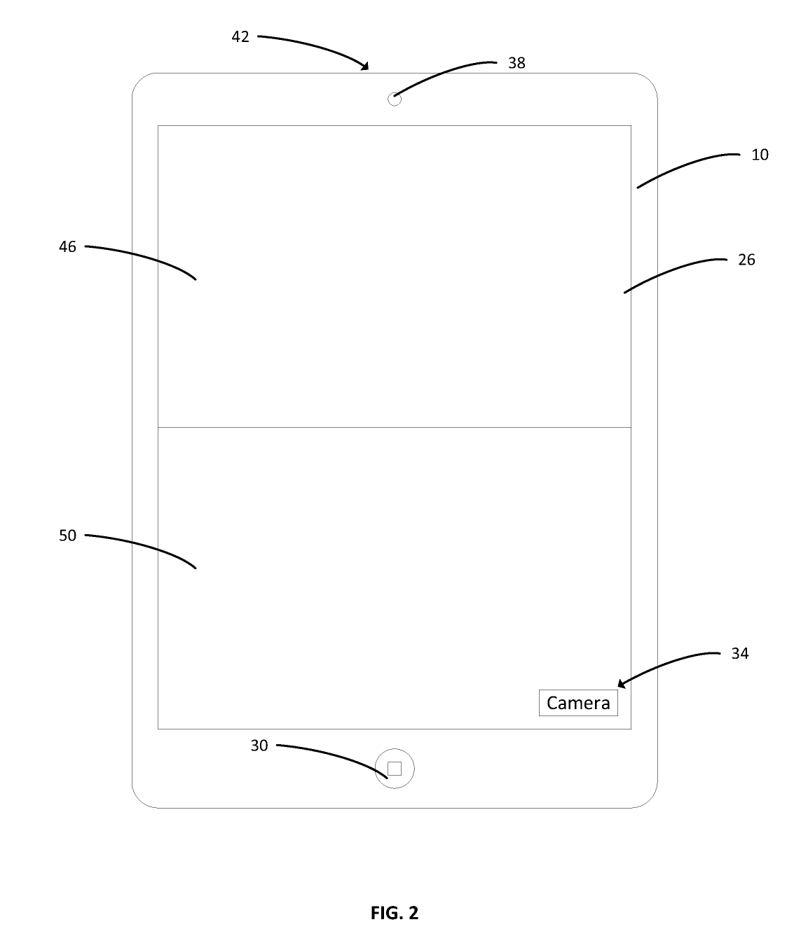

Referring to FIG. 2, a drawing of a tablet computer 10 is shown. The tablet computer 10 includes a body or case which houses internal electronics such as a processor, memory, battery, wireless communications device, etc. The tablet computer 10 includes a user interface such as screen 26. Typically, the screen 26 is a display screen which presents information to a user and is also a touch screen which accepts inputs from a user to allow the user to control the tablet computer 10. The tablet computer 10 may include various hardware buttons 26 which allow a user to operate the device, navigate through menus, etc. The tablet computer 10 may include various software buttons 34 which allow a user to select software, change software or hardware settings, etc. The tablet computer 10 may also include a camera 38. In one example, the tablet computer 10 includes a front facing camera 38 and a rear facing camera 42.

The tablet computer 10 may be used in multiple ways by transport staff to facilitate the care of a patient. The tablet computer 10 may provide secured video communications between transport staff and medical personnel. In one example, the tablet computer 10 is provided with patient transport software which a user may operate to facilitate patient transport and care. A user may utilize video communications software in the patient transport software. The video communications software may typically require that a person log into the software before permitting use. The user may enter a username and password to authenticate and may then select and call another person for video communications. In this example, transport staff may call medical personnel.

The video communications software may divide the screen 26 into an upper screen section 46 and a lower screen section 50. The upper screen section 46 may display images (herein used generically to include video and video images) captured by a tablet computer camera and the lower screen section 50 may display images captured by a remote computer 18 or tablet computer 10. The tablet computer 10 may use a microphone and speakers to receive and produce sound.

The transport staff may use a hardware button 30 or software button 34 to select between a front facing camera 38 and a rear facing camera 42. The transport staff may use a front facing camera 38 to capture their own face and surroundings and present this to another person such as the medical personnel. The transport staff may use a rear facing camera 42 to capture images of the patient and present these to the medical personnel. In this manner, the video communications software may facilitate better communications between the transport staff and remote medical personnel such as the responsible doctor and may allow the medical personnel to observe the conditions of the patient and provide input and direction to the transport staff as to the appropriate care for the patient. The transport staff may use the rear facing camera 42 to capture images of the patient and these images by be simultaneously transmitted to the medical personnel as well as displayed on the upper screen section 46. The transport staff can simultaneously see and hear the medical personnel and the patient image, facilitating quick and accurate capturing of relevant images.

The video communications software may also be used for introducing persons. When a patient is transported to a care facility, the family or a previous treating physician will typically not be transported with the patient. The video communications software may be used to introduce the family or previous treating physician to the receiving medical personnel.

The video communications software may automatically record and store a copy of the video communication. In one example, a copy of the video communication may be stored on the tablet computer 10. The transport staff may review the video communication to review any instructions provide by the medical personnel. A copy of the video may be stored on a server 14 or computer 18 associated with the receiving care facility, allowing receiving medical personnel to review the video to better assess the condition of the patient and to provide quality control for the transport.

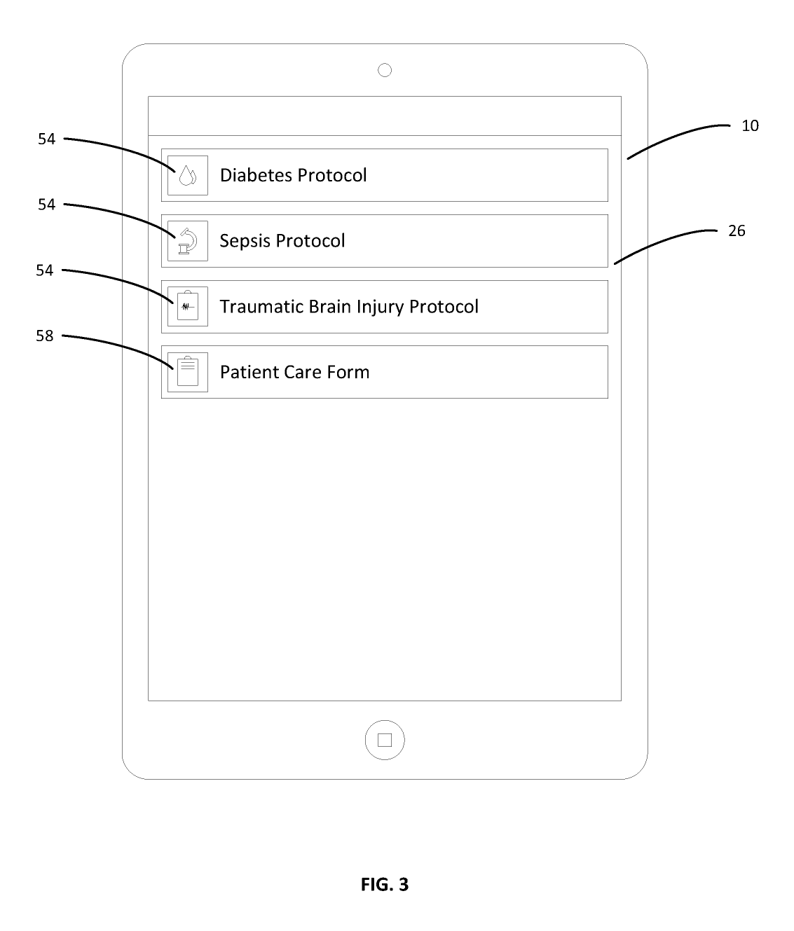

Referring now to FIG. 3, the patient transport software may provide and receive patient information and care information. The patient transport software may include various transport care protocols 54 and may provide software buttons to allow transport staff to access the transport care protocols 54. Additionally, the patient transport software may include a patient care form 58 which is similarly accessible.

Transport care protocols 54 address specific patient types, specific patient conditions, and treatment specific to transport. A transport care protocol may thus be specific to children or specific to adults, as these will have different needs for medical treatment during transport. A transport care protocol may also be specific to specific patient conditions. The tablet computer 10 may include transport care protocols specific to diabetes, sepsis, and traumatic brain injury, for example. These conditions have been determined to be particularly relevant to patient transport software as they each require medical care during transport, are particular to the type of patient, and extend beyond the emergency medical training common to transport staff.

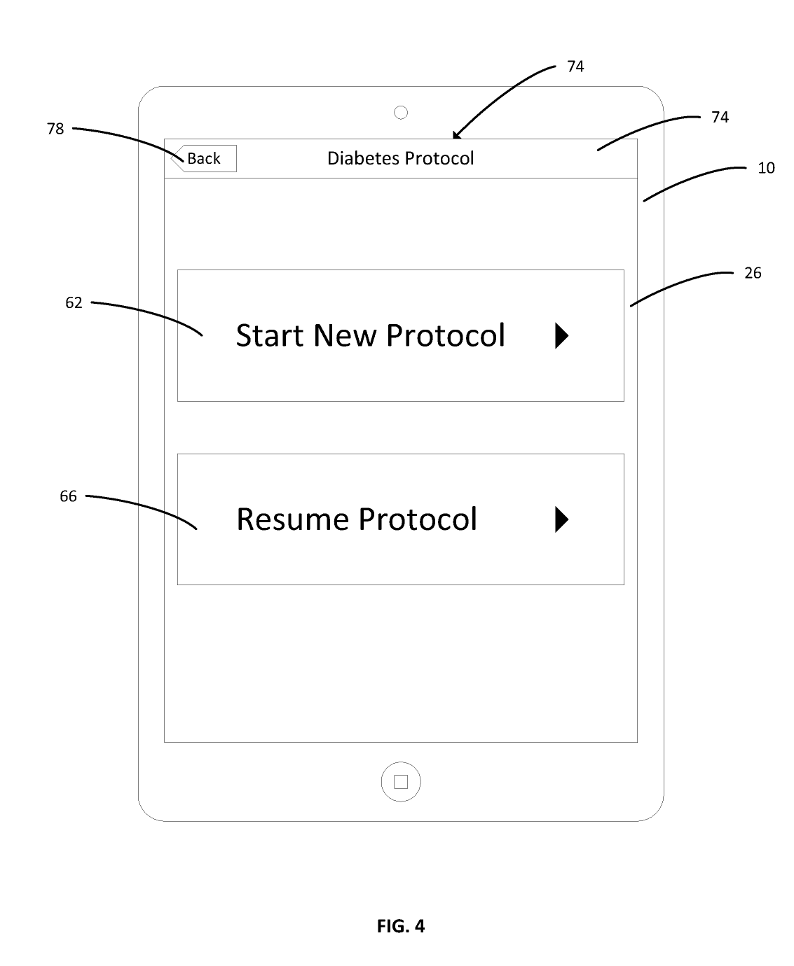

If transport staff selects a transport care protocol such as the diabetes protocol, they are presented with a screen such as is shown in FIG. 4. Various Figures display the tablet computer 10 and show different screens which are presented to transport staff to facilitate patient care. The various screens typically include patient care instruction and typically include software buttons to allow transport staff to use the transport care protocol to provide medical care to the patient.

When the transport staff selects a transport care protocol 54, they may be asked if they want to start a new protocol 62 or resume a previous protocol 66 (to continue providing care to a patient being transported). A header bar 70 may be provided which identifies the current transport care protocol 74 and provides a BACK software button 78 to allow transport staff to return to a previous screen.

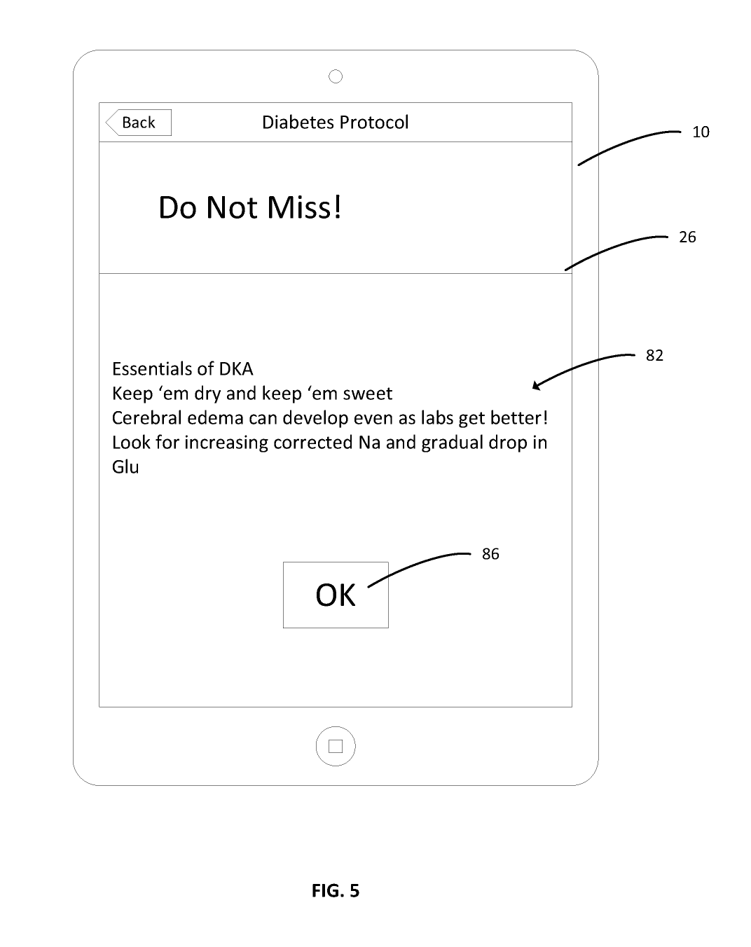

FIG. 5 shows a warning screen which may be displayed upon entering a transport care protocol. The warning screen may display a warning 82 which contains important information which the transport staff should be aware of during the duration of the patient transport. The transport staff may be required to press a button 86 to move beyond the warning screen.

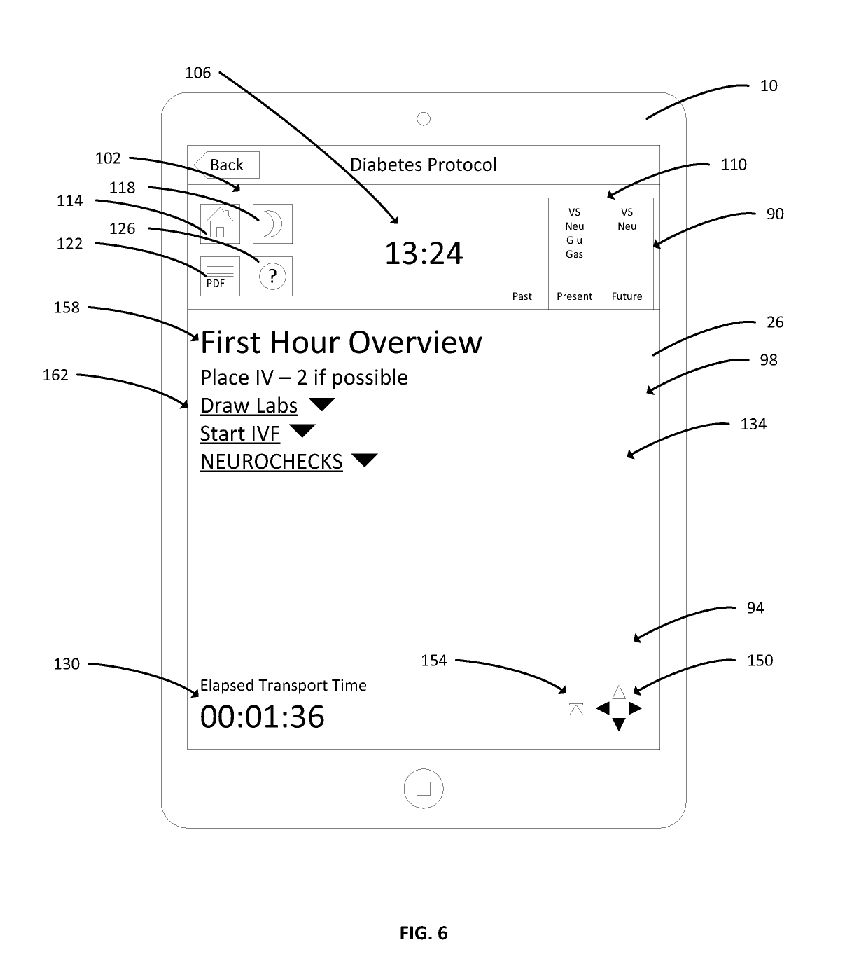

FIG. 6 shows the transport care protocol as it may be displayed on a tablet computer 10. The transport care protocol may present various different pieces of information to the transport staff. The area of the screen 26 may be divided into a header 90, a footer 94, and a body section 98. The header 90 may include feature navigation buttons 102, a countdown timer 106, and a timeline overview 110. The feature navigation buttons 102 may include a home button 114, a lighting button 118, a PDF (document display) button 122, and a help button 126.

Pressing the home button 114 will take a user back to where they were (i.e. back to where they currently should be) in the transport care protocol. In caring for a patient during transport, transport staff may navigate through different screens, pages, or features of the transport care protocol. They may be reviewing future care tasks, finding a term in a glossary, etc. When the user presses the home button 114 the user is returned to where they were in the transport care protocol.

Pressing the lighting button 118 will switch the screen display between conventional black text on a white background to white text on a black background. Switching to white text on a black background will lower the overall brightness of the screen and may make use of the tablet computer 10 more compatible with patient transport in a helicopter.

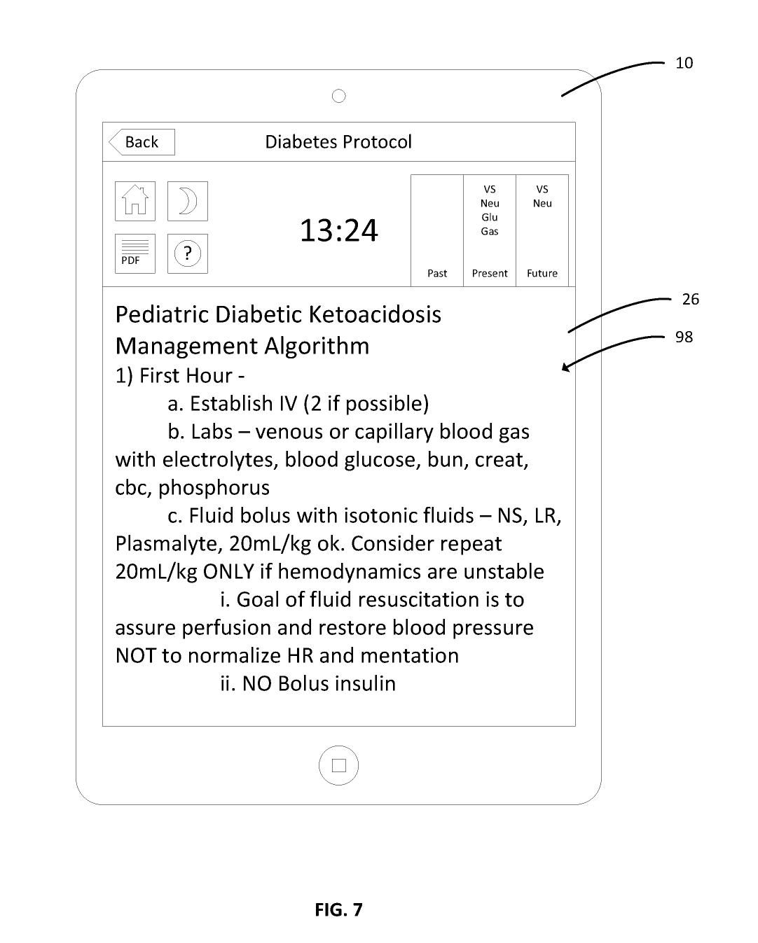

Pressing the PDF button 122 will display the transport care protocol in a conventional document outline format rather than the tiled format. The document outline format is shown in FIG. 7. As shown, the transport care protocol is displayed in the body section 98 of the screen 26. A user may touch the screen and drag the document up or down to scroll through the document. The user may touch the home button 114 to return to their location in the tiled view of the patient care protocol.

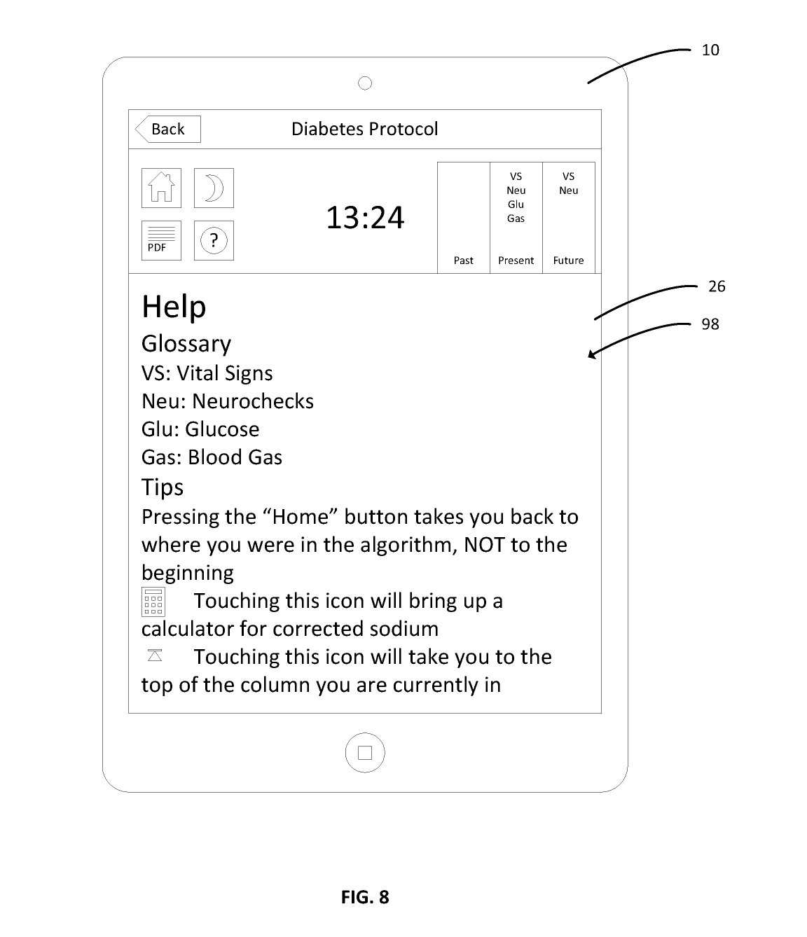

Pressing the help button 126 will display a help screen. FIG. 8 displays the help screen, which presents information about the transport care protocol in the body section 98 of the screen 26. The help screen may display various acronyms used in the transport care protocol and their meanings. The help screen may also display tips regarding the functionality of the transport care protocol and the meaning of various icons used in the protocol.

Referring back to FIG. 6, the header 90 displays a timeline overview 110. The transport care protocol provides patient care instructions which are divided into particular time periods which occur during transport of the patient. These time periods may include: the first fifteen minutes of transport, the first 30 minutes of transport, the first hour of transport, the second hour of transport, and subsequent hours of transport. Each of these time periods may include different care procedures and may include different desired results or patient responses. The timeline overview 110 includes three separate sections for the Past time period, the Present time period, and the Future time period. Each of these sections may include acronyms which represent tasks which should be performed in providing patient care. These acronyms are those which are found in the help display shown in FIG. 8 and which are used throughout the transport care protocol. Transport staff may look at the timeline overview 110 and quickly see what patient care tasks should have been previously completed, which tasks they should be working on currently, and which tasks will be done in the upcoming time period.

The header also contains a countdown timer 106. The countdown timer 106 displays the time remaining in the current time period. A user may look at the countdown timer and ascertain how much time remains to complete patient care tasks during the present time period. The countdown timer begins automatically as the transport care protocol is initiated and resets automatically to a new time value as new patient care time periods begin. Thus, if the transport care protocol includes a ‘first fifteen minutes’ and a ‘fifteen to thirty minutes’ time periods, the countdown timer 106 may begin to count down from fifteen minutes when the transport care protocol is initiated. When the timer reaches zero, the tablet computer 10 may move to the second time period of the transport care protocol and may restart the countdown timer at fifteen minutes (the time remaining in the second time period).

The footer 94 includes a timer 130 which displays the elapsed transport time. The timer 130 is automatically started when the transport care protocol is initiated. Transport staff may quickly view the elapsed transport time to determine how long care has been provided, etc. If the transport care protocol is closed, such as to allow use of the video communications program or other features, the transport staff may again open the transport care protocol and they are asked if they want to start a new protocol or resume a protocol (as shown in FIG. 4). The tablet computer 10 stores the information which has been entered into the transport care protocol including the time information and may allow the transport staff to return to the protocol at the same time/condition as if they did not exit the protocol.

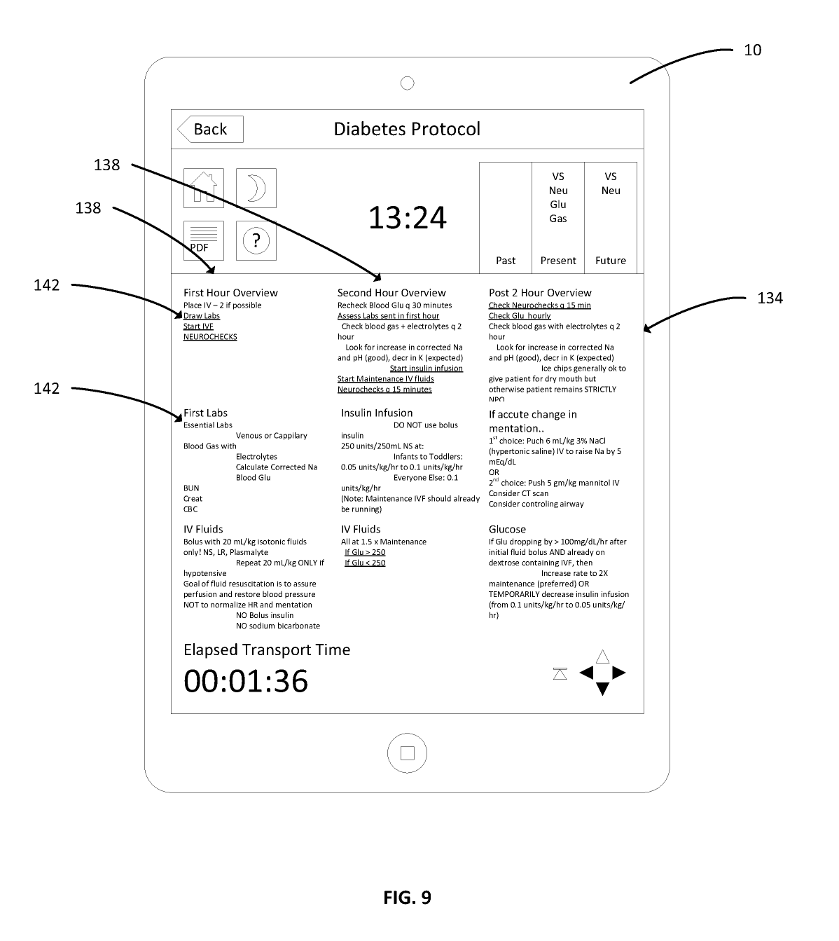

The body 98 of the screen 26 displays patient care tasks associated with the transport care protocol. The transport care protocol is organized in a tiled array as shown in FIG. 9. Each page of the transport care protocol may be viewed as a ‘tile’ and the various tiles or pages 134 are arranged into a spatial matrix of columns 138 and rows 142. Each column 138 in the array contains pages 134 associated with a particular patient care time period. Each page 134 within a particular column typically represents a patient care task or tasks which are performed during the time period. A user may use gestures to display the transport care page matrix as shown in FIG. 9, such as by touching the screen 26 with two fingers and pinching the fingers together. The user may then touch the screen 26 and swipe their finger left, right, up, or down to move the transport care page matrix to see a desired portion of the matrix. The user may touch a particular page tile 134 to go to that page within the transport care protocol.

When the user is viewing a single page of the transport care protocol as shown in FIG. 6, the user may similarly navigate through pages of patient care tasks. The user may touch the tablet computer screen 26 with a finger and swipe the finger left or right to move to protocol pages pertaining to different patient care time periods and may touch the screen 26 and swipe up or down to move between protocol pages within a patient care time period.

The footer 94 also contains software buttons to navigate through different pages of patient care tasks. The footer 94 contains software buttons 150 which a user may press to navigate left, right, up, and down through pages of patient care tasks. The footer 94 also contains a software button 154 which navigates to the top of a column 138, displaying the first page pertaining to a particular patient care time period. The software buttons 150, 154 may be highlighted to show those buttons which will currently produce an action (i.e. the ‘up’ button and ‘top’ button will not currently produce an action as the user is viewing the top page within the particular column 138 or time period).

As is shown in FIG. 9, the exemplary transport care protocol is for transport care of a person with diabetes. The protocol includes patient care time periods associated with the first hour of transport, the second hour of transport, and subsequent transport time. These time periods can be seen in the three columns 138 of patient care task pages.

FIGS. 6, 10, 11, 12, and 13 show pages 134 with patient care tasks associated with the first hour of transport. FIG. 6 shows an overview of the first hour of transport in the body section 98 of the tablet computer screen 26. Such a page 134 is displayed when a patient care time period begins. The initial page in a patient care time period may show the time period as a heading 158 (First Hour Overview) and may show the basic patient care tasks 162 underneath the heading 158. The basic care tasks 162 may be hyperlinks or software buttons which take the transport staff to the page showing detailed instructions for this care task. Within the column 138 of pages 134 for the first patient care time period, the rows of pages underneath the initial (upper) page show details regarding the patient care tasks 162. A user may navigate down through the pages 134 beneath the initial page shown in FIG. 6 by swiping up on the tablet computer screen 26, pressing the down button 150, or pressing on the underlined care tasks 162. Navigating down through the pages 134 will take the transport staff through the pages 134 displayed in FIGS. 6, 10, 12, and 13. Navigating in this manner will guide the transport staff chronologically through the patient care tasks appropriate for the particular type of patient. The transport staff will typically work down through a column 138 of patient care tasks during the associated patient care time period and then advance to the next column 138 of patient care tasks in the next patient care time period.

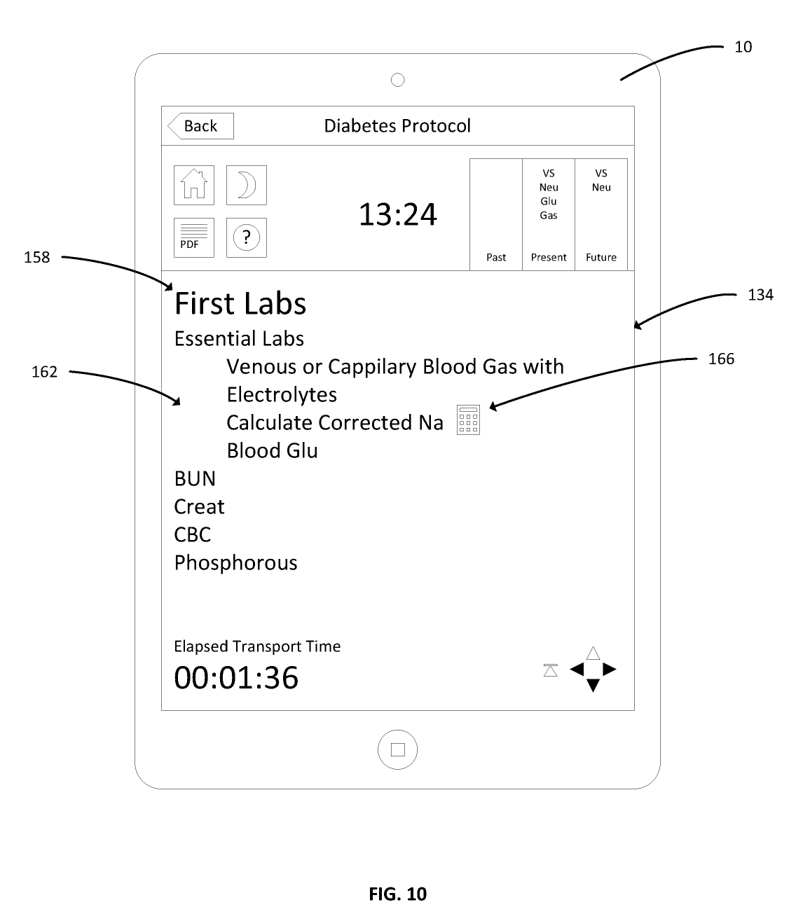

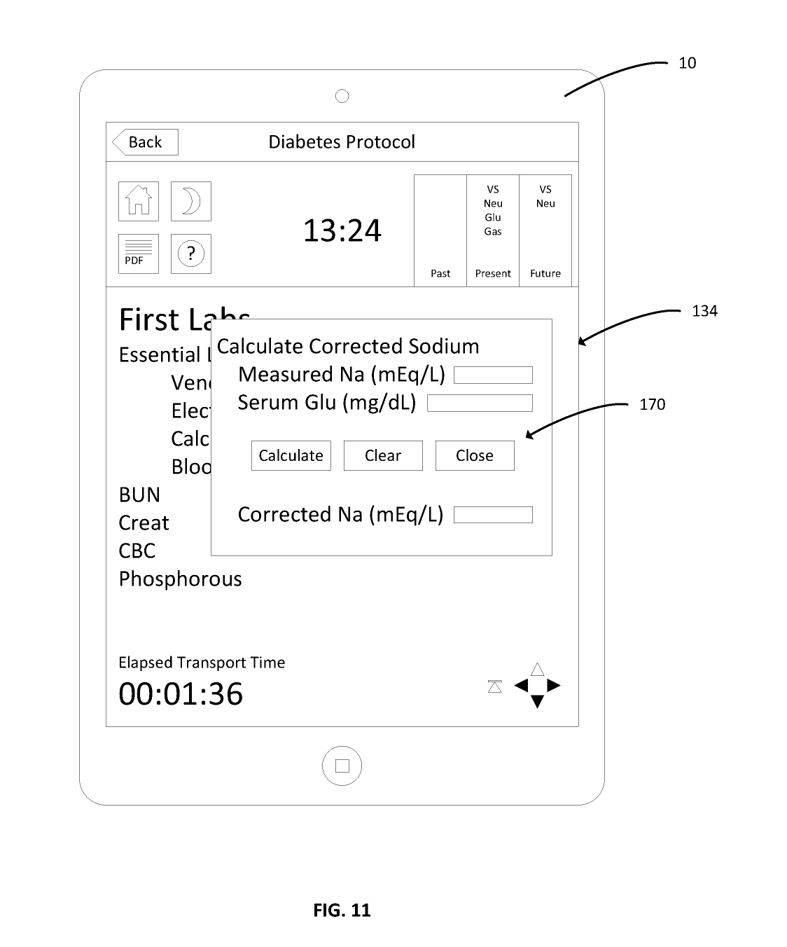

FIG. 10 shows the patient care tasks of completing first lab work for the patient. The page 134 displays the types of lab work which needs to be completed by the transport staff. The page 134 displays a calculator icon 166. Pressing the calculator icon 166 will bring up a calculator window 170 (shown in FIG. 11) which contains locations where transport staff may enter measured values and automatically determine a corrected value for a patient condition; corrected blood sodium in this example. In this manner, the transport care protocol automatically provides transport staff with information, calculators, etc. in the order and at the time needed by the transports staff.

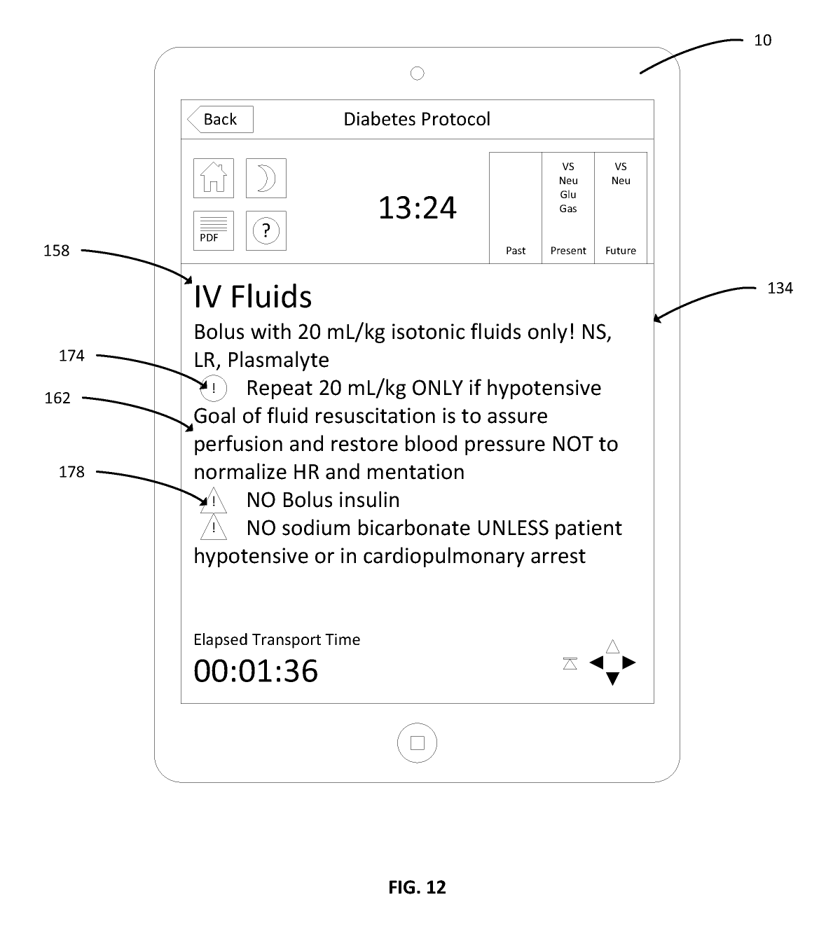

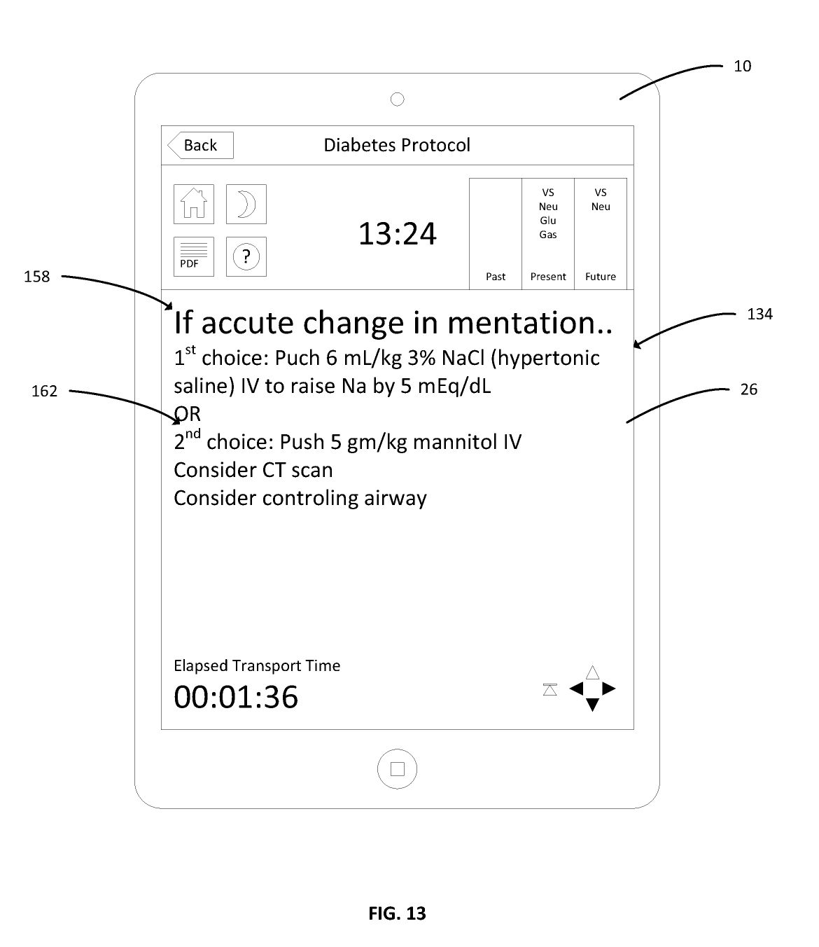

FIGS. 12 and 13 show subsequent pages 134 of patient care tasks pertaining to the first patient care time period. The patient care tasks may include important information and warnings, and may include icons such as an information icon 174 which provides guidance as to administering care to the patient and a warning icon 178 which alerts the transport staff as to care actions which should not be taken. The patient care protocol guides the transport staff in administering care to a patient which is specific to the patient conditions and which is specific to transport of the patient.

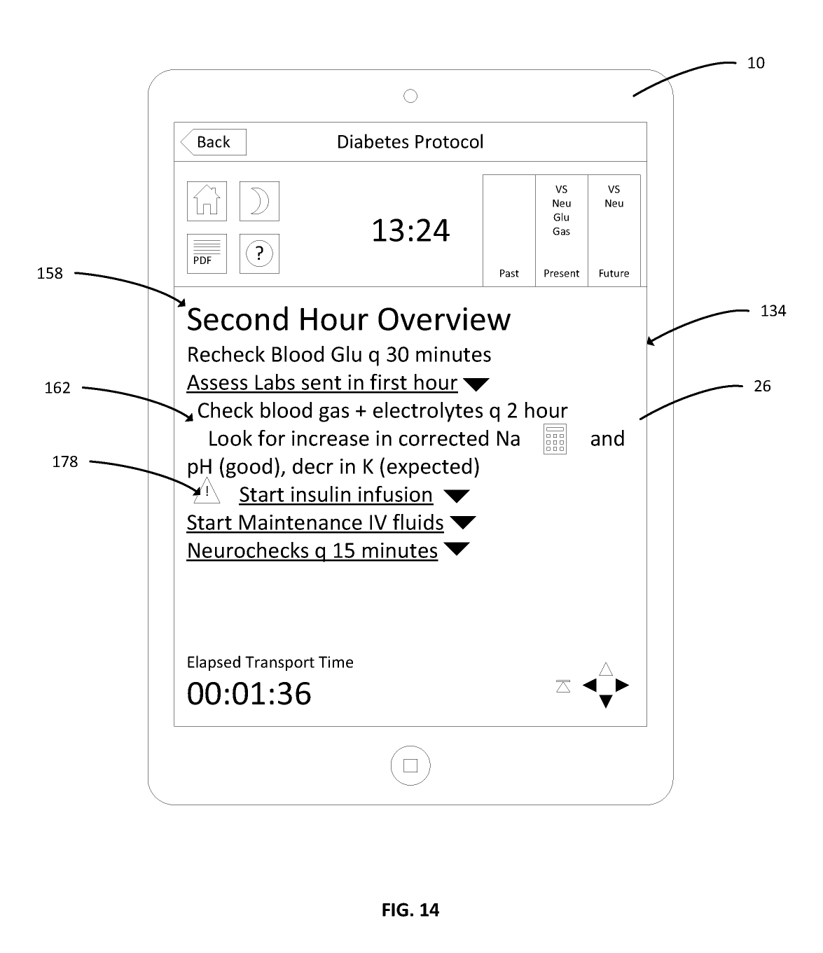

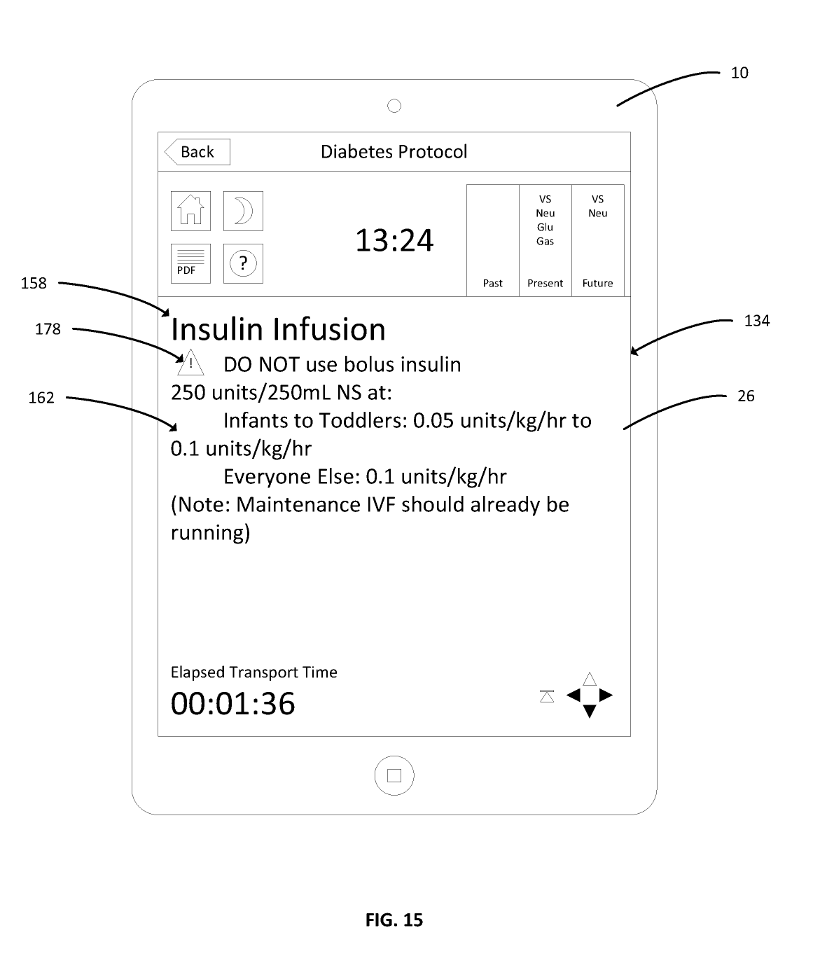

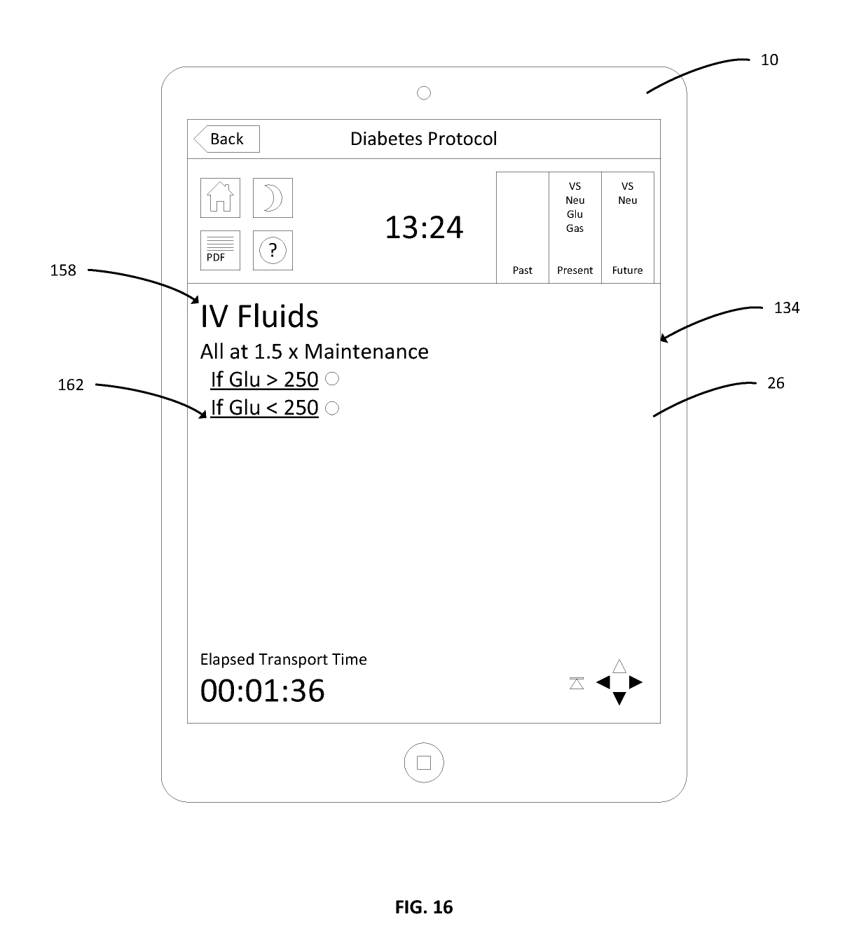

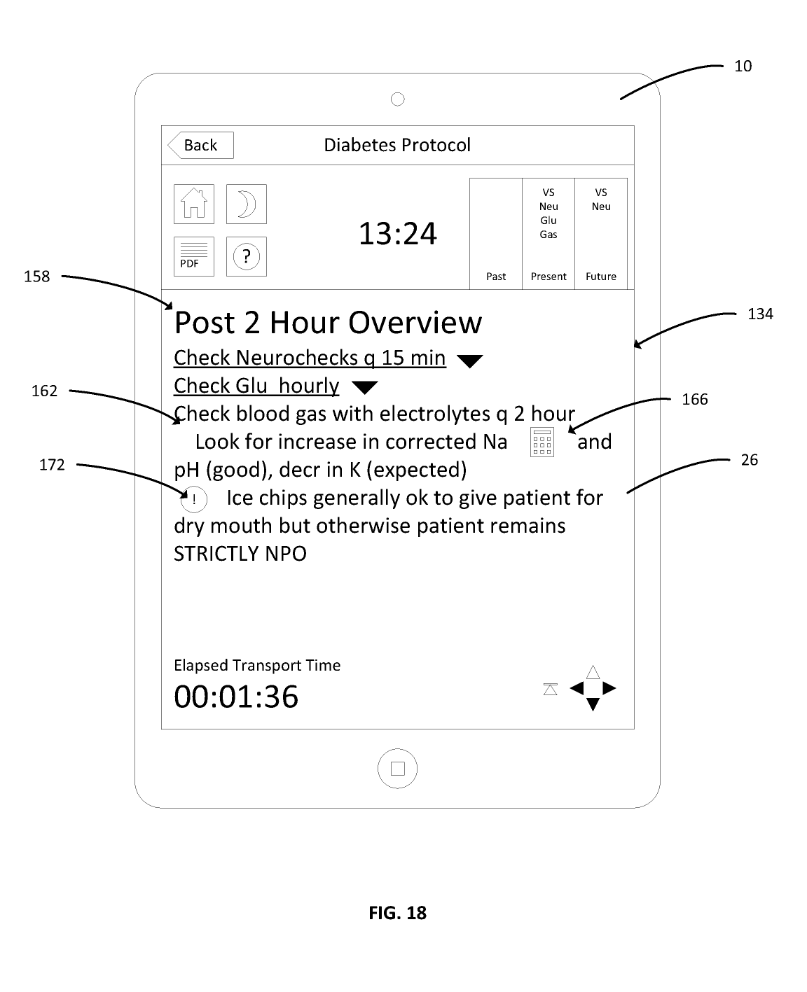

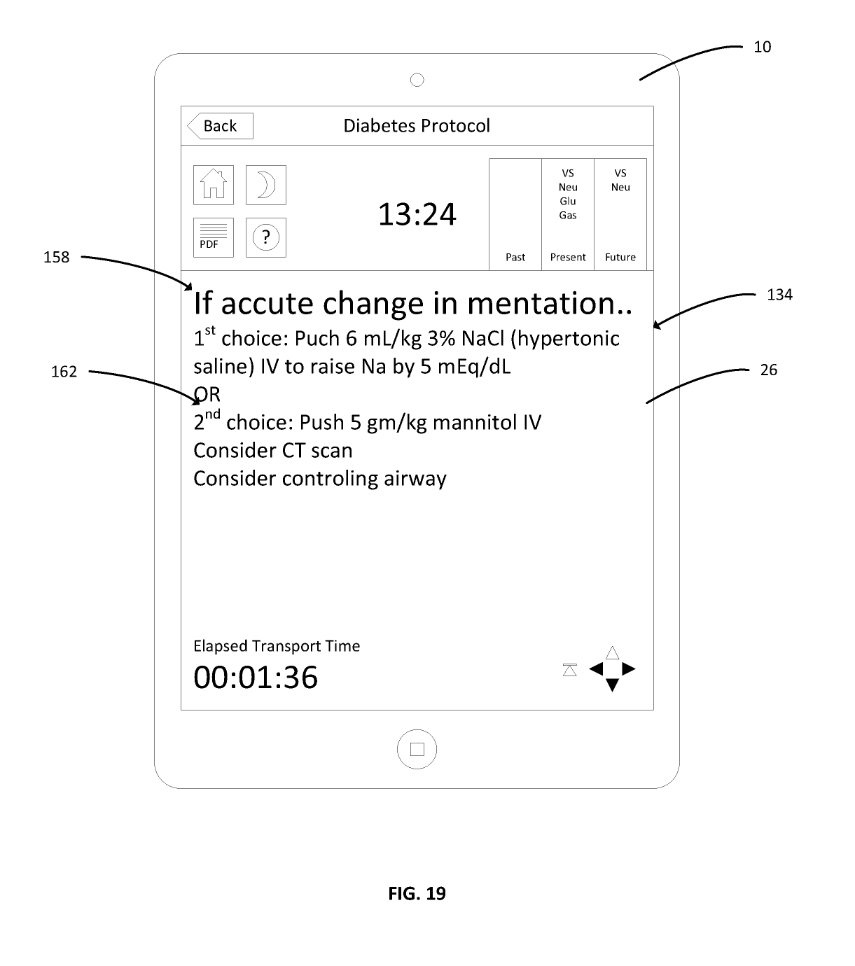

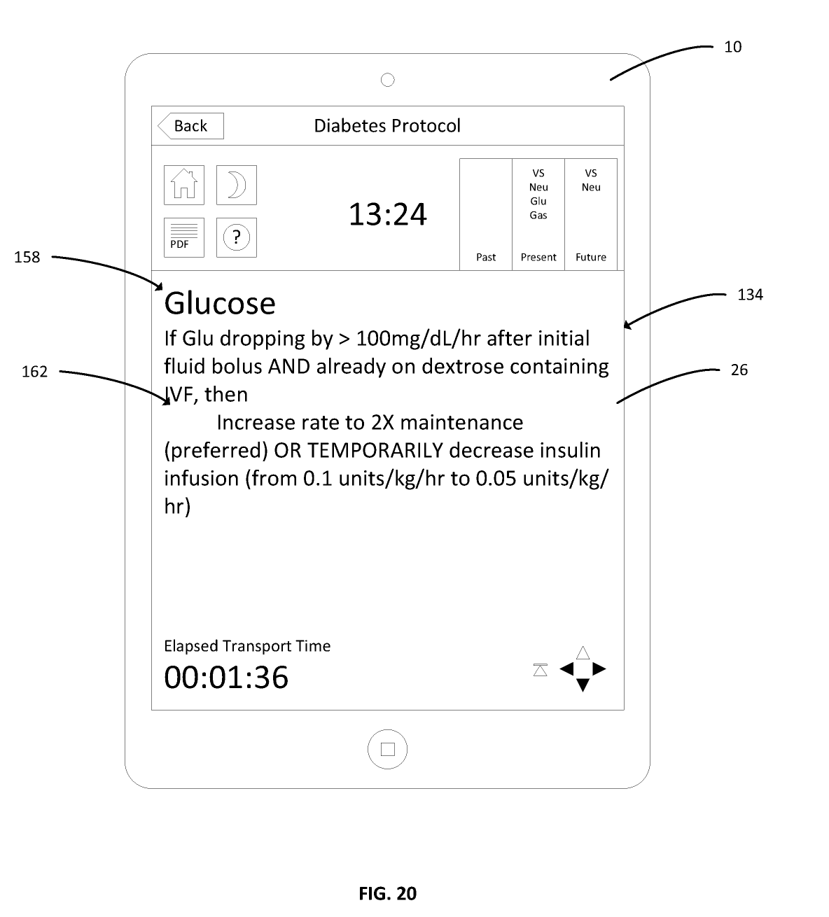

FIGS. 14-17 and 18-20 show patient care tasks which are to be completed during the second patient care time period and the third patient care time period respectively. The transport care protocol guides the transport staff in what changes should be expected in patient conditions as well as what care actions should be taken. The transport care protocol pages 134 may display various calculators 166 and icons 172, 178 as are appropriate.

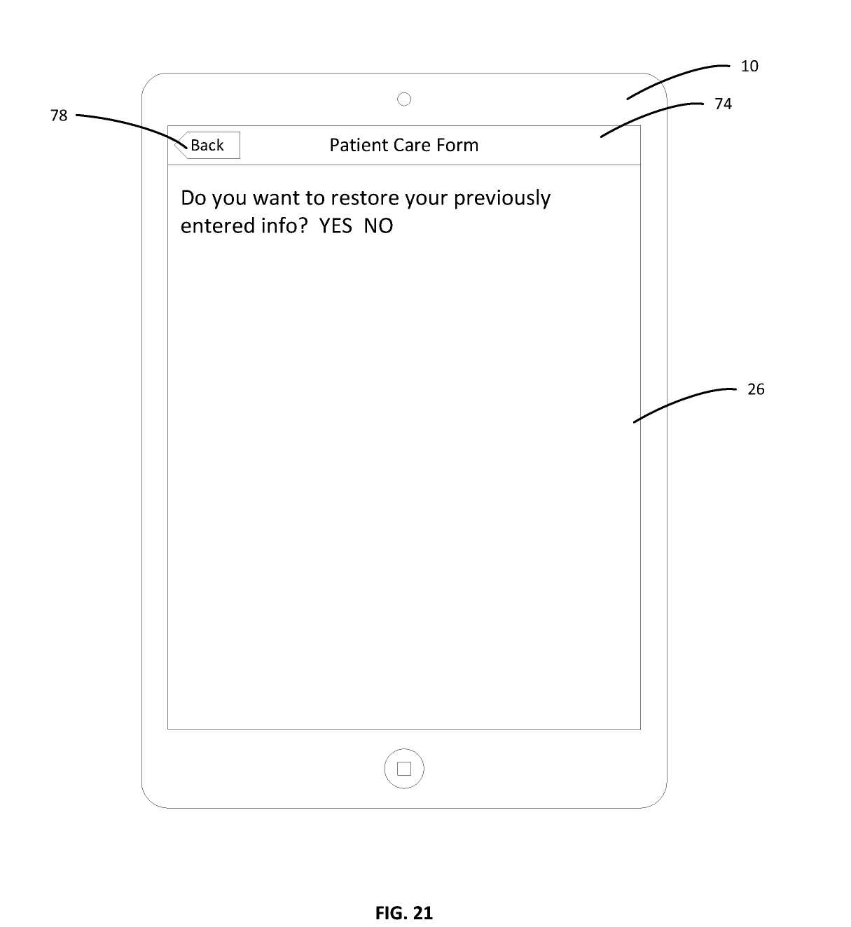

FIG. 21 shows an electronic patient care form which may be selected from the patient transport software display shown in FIG. 3. Upon selecting the patient care form 58, the transport staff may be prompted to select whether they desire to restore previously entered information or not. The transport staff may thus decide enter additional information for a current transport patient or enter information for a new patient.

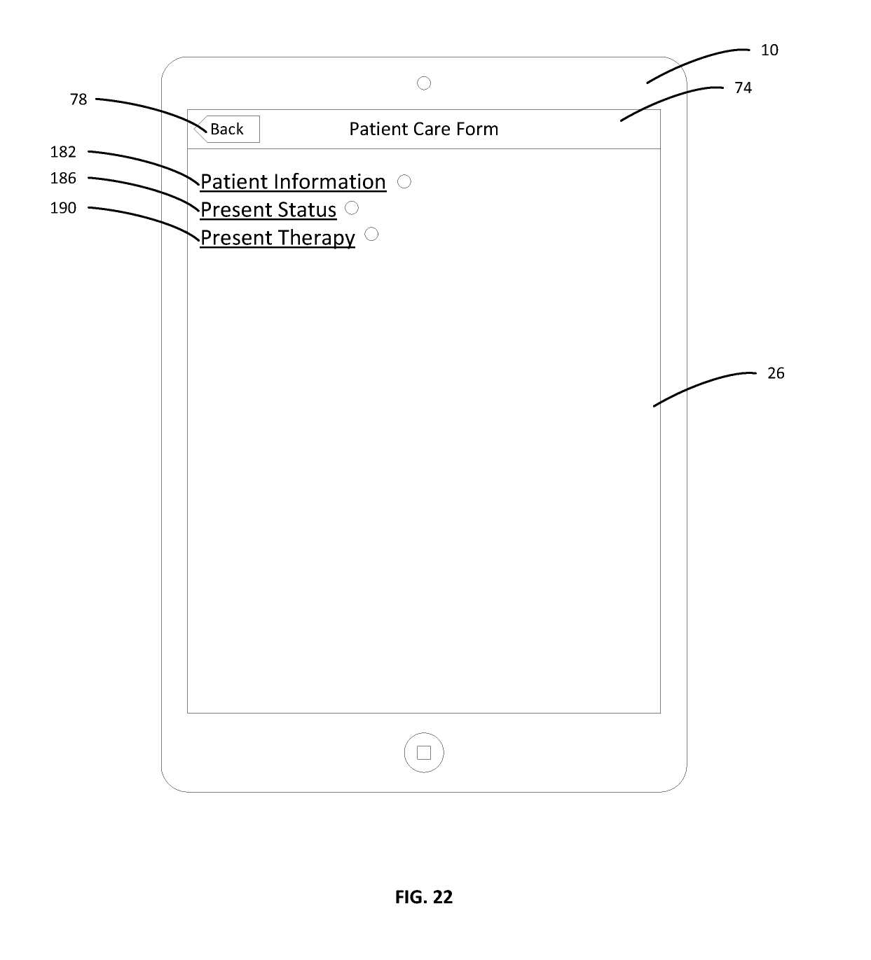

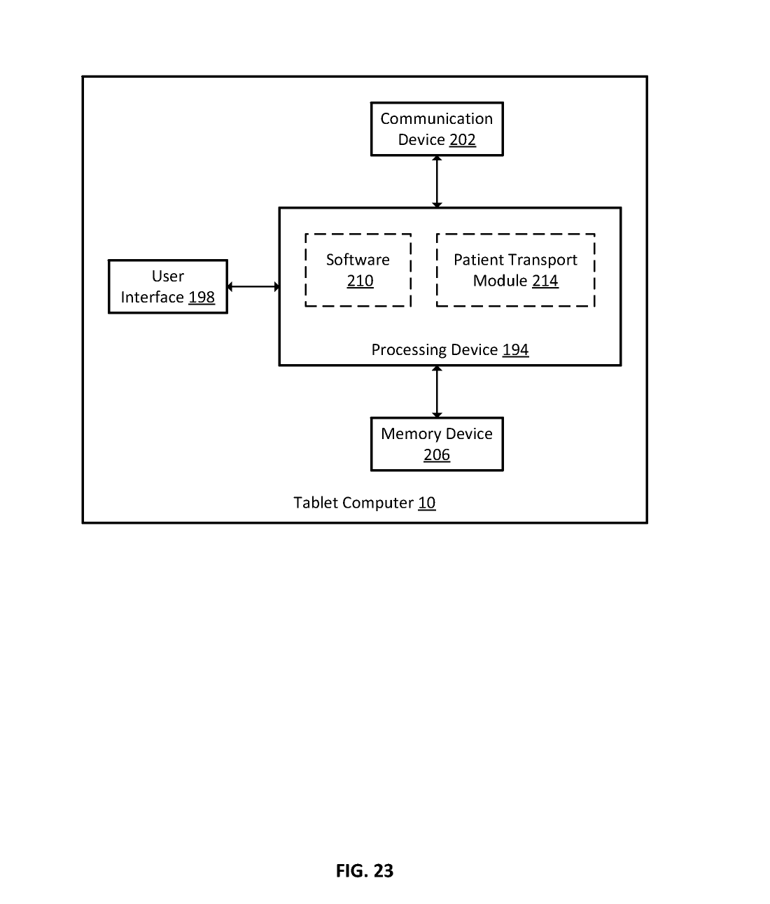

As shown in FIG. 22, the patient care form may allow transport staff to further select between entering patient information 182, entering patient status 186, and entering patient therapy 190. For each selection, the transport staff may be provided with an electronic notepad type application where they can enter desired information. Patient information 182 may often include patient identification and other information surrounding the patient. Patient status 186 may often include the patient's physiological information and may include injuries, test results, etc. Patient therapy 190 may often include the type, quantity, and schedule of information which has been administered to the patient.

As shown in FIG. 1, the tablet computer 10 may be connected to a hospital server 14 or computers 18 via the internet or via wireless communications such as WIFI or a cellular network. Patient information including test results and information entered into the transport care protocol and information entered into the patient care form may be transmitted to a server 14 or computer 18 at the hospital or care facility. If desired, the information may be transmitted to both a transferring facility and a receiving care facility. In this manner, medical personnel at the care facility may automatically receive information about the patient and the patient status and may, upon receipt of the patient, more smoothly resume care of the patient. The care facility may be able to treat the patient as if resuming care of an existing patient rather than initiating care of a new patient, improving the care of the patient.

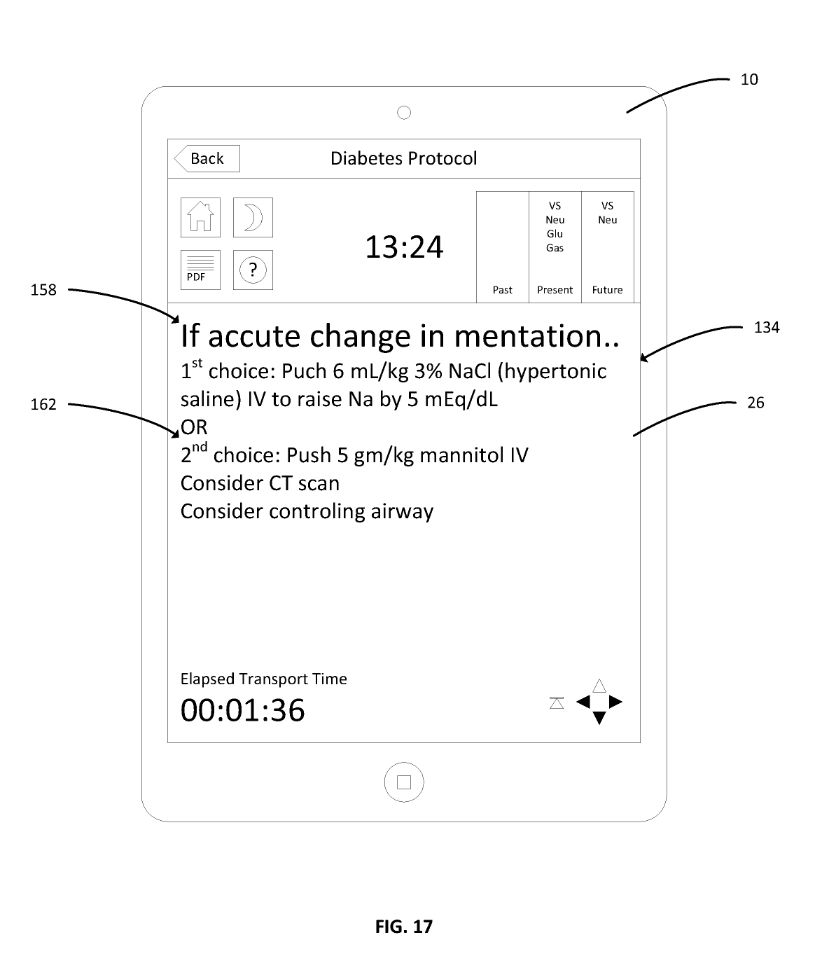

Referring now to FIG. 17, a schematic illustrating example components of the tablet computer 10 is shown. The tablet computer 10 includes a processing device 194, a user interface 198, a communication device 202, and a memory device 206. It is noted that the tablet computer 10 can include other components and some of the components are not required.

The processing device 194 can include memory, e.g., read only memory (ROM) and random access memory (RAM), storing processor-executable instructions and one or more processors that execute the processor-executable instructions. In embodiments where the processing device 194 includes two or more processors, the processors can operate in a parallel or distributed manner. The processing device 194 can execute the operating system of the tablet computer 10. In one example, the processing device 194 also executes a software module 210 such as patient transport software and a patient transport module 214.

The user interface 198 is a device that allows a user, transport staff in particular, to interact with the tablet computer 10. While one user interface 198 is shown, the term “user interface” can include, but is not limited to, a touch screen, a physical keyboard, a mouse, a camera, a microphone, and/or a speaker. The communication device 202 is a device that allows the tablet computer 10 to communicate with another device, e.g., the server 14, computer 18, or another tablet computer 10. The communication device 202 can include one or more wireless transceivers for performing wireless communication and/or one or more communication ports for performing wired communication. The memory device 206 is a device that stores data generated or received by the tablet computer 10. The memory device 206 can include, but is not limited to, a hard disc drive, an optical disc drive, and/or a flash memory drive.

The patient transport module 214 allows a user, transport staff in particular, to receive patient care tasks and protocols, to process and enter patient information, and to perform various tasks in caring for a patient during transport as discussed herein. The patient transport module 214 may execute or facilitate video communications, a patient care form, and patient care protocols as discussed herein.

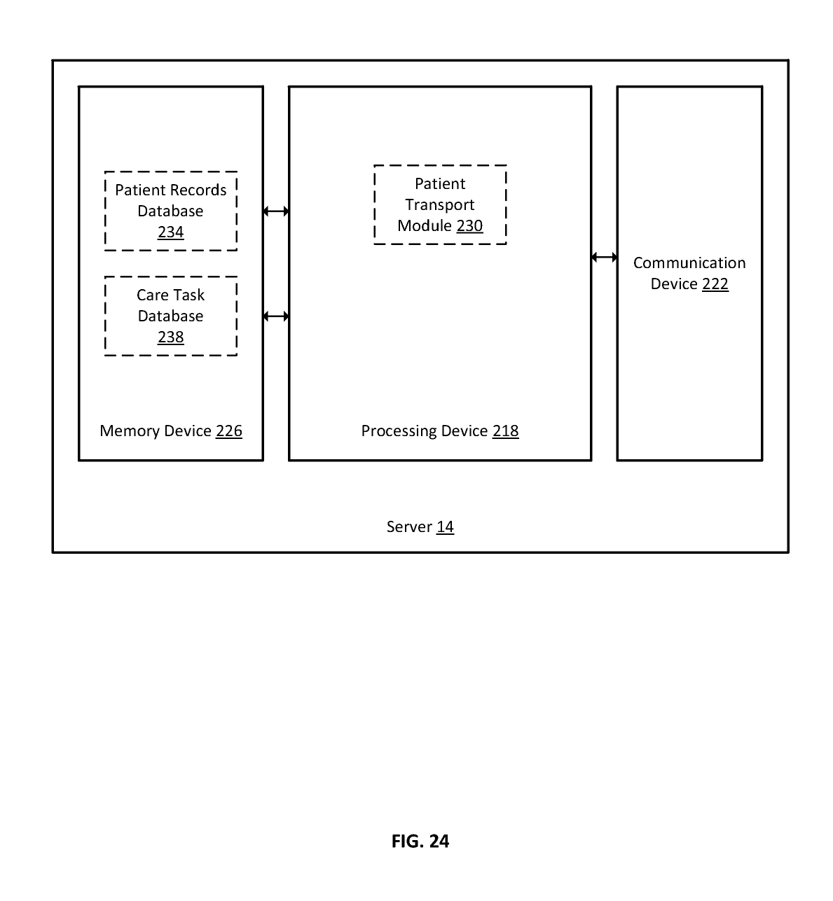

The server 14 or computer 18 may be programmed to perform one or more functions at the request of the tablet computer 10 and, according to various computing models, may execute some or all of the functions associated with operation of the patient transport software. FIG. 24 illustrates an example embodiment of a server 14 (or computer 18) which is programmed to perform one or more of the requested functions. The server 14 may include a processing device 218, a communication device 222, and a memory device 226.

The processing device 218 can include memory, e.g., read only memory (ROM) and random access memory (RAM), storing processor-executable instructions and one or more processors that execute the processor-executable instructions. In embodiments where the processing device 218 includes two or more processors, the processors can operate in a parallel or distributed manner. In the illustrative embodiment, the processing device 218 executes a patient transport module 230. The patient transport module 230 may execute or facilitate video communications, a patient care form, and patient care protocols as discussed herein.

The communication device 222 is a device that allows the server 14 or computer 18 to communicate with another device, e.g., the tablet computer 10. The communication device 222 can include one or more wireless transceivers for performing wireless communication and/or one or more communication ports for performing wired communication.

The memory device 226 is a device that stores data generated or received by the server 14. The memory device 226 can include, but is not limited to a hard disc drive, an optical disc drive, and/or a flash memory drive. Further, the memory device 226 may be distributed and located at multiple locations. The memory device 226 is accessible to the processing device 218. In some embodiments, the memory device 226 stores a patient records database 234 and a care task database 238.

In some embodiments, the patient records database 234 can store information associated with a patient. The patient records database 234 may, for example, store information associated with a patient and may include identifying information, contact information, patient care instruction, etc. The patient records database 234 may be queried by the processing device 144 and may provide information to the processing device to facilitate identifying patients and to facilitate treatment of the patient during transport.

In some embodiments, the patient records database 234 may receive patient information from the tablet computer 10. The patient records database may receive patient identification and care information from the tablet computer 10. The information may be entered into the tablet computer 10 during transport and may be transmitted to the patient records database during transport or when the patient and tablet computer 10 arrive at a care facility.

The care task database 238 may store information regarding care tasks associated with treatment of a patient during transport. For example, the care task database 238 may store the data fields and care task information associated transport care protocols. The care task database 238 may be queried by the processing device 218 and may transmit information to the processing device to facilitate the use of transport care protocols.

The processing device 218 may execute the patient transport module 230. The patient transport module 230 may receive patient information such as patient records and care task information, create transport care protocols, provide transport care protocols to the tablet computer 10, etc. The patient transport module 230 may receive patient care and records information from the tablet computer 10 and facilitate the entry of patient information into server 14 or computer 18 to facilitate proper care of a patient during transport and seamless care of a patient at the receiving care facility.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer system comprising:
a portable tablet computer used during transport of a patient to a care facility to facilitate medical care of the patient;
a patient transport module programmed to display, on the portable tablet computer, a transport care protocol which sequentially displays pages of patient care tasks which are specific to transport of a patient with a predetermined medical condition, and wherein the pages of patient care tasks are automatically displayed within predetermined patient care time periods or assessment categories during the transport of the patient.

2. The computer system of claim 1, wherein the transport care protocol continuously displays a timeline overview which provides an overview of patient care tasks which are performed in past, present, and future patient care time periods representing different time periods during transport of a patient to a care facility.

3. The computer system of claim 1, wherein the transport care protocol displays a countdown timer which displays time remaining in a current patient care time period representing a portion of the total time during patient transport to a care facility and wherein the transport care protocol displays an elapsed transport time representing total elapsed time in transporting a patient to a care facility.

4. The computer system of claim 1, wherein the transport care protocol provides multiple patient care time periods of predetermined duration representing time to transport a patient to a care facility and wherein the transport care protocol chronologically presents patient care tasks specific to each time period to a user as each patient care time period begins.

5. The computer system of claim 4, wherein each patient care time period is associated with predetermined patient care tasks.

6. The computer system of claim 4, wherein:
patient care tasks for different patient care time periods or assessment categories are presented in different columns, with a particular column associated with a particular patient care time period or assessment category;
patient care tasks for a patient care time period or assessment category are separated into types of patient care tasks;
information and care steps for different types of patient care tasks are separated as different display pages within a column associated with a patient care time period or assessment category; and
display pages within a patient care time period or assessment category are separated and arranged as rows within the column associated with the patient care time period or assessment category.

7. The computer system of claim 1, wherein:
the transport care protocol comprises a plurality of pages of patient care tasks;
pages of patient care tasks are presented in an array having multiple columns and multiple rows;
an array column comprises pages of patient care tasks to be performed: a) during a predetermined patient care time period, b) a change in clinical status, or c) a comprehensive organ system assessment during transport of the patient;
rows of pages within a column represent different types of patient care tasks to be performed;
a user may scroll vertically through pages of patient care tasks pertaining to a particular column; and
the user may scroll horizontally through columns pertaining to groups of patient care tasks.

8. The computer system of claim 7, wherein the transport care protocol comprises a home button programmed to return a user to an appropriate location within the transport care protocol based on a current patient care time period.

9. The computer system of claim 1, wherein the patient transport module is further programmed to provide encrypted video communications between the tablet computer and a remote computer and allow a user to select between a front facing camera to capture and display images of the user and a rear facing camera to capture and display images of a patient.

10. The computer system of claim 1, wherein the patient transport module is further programmed to provide an electronic patient care form which receives patient information regarding a patient who is being transported and automatically transmit patient information to a computer at a receiving care facility to create an electronic patient record.

11. A computer implemented method comprising:
a patient transport module presenting patient care tasks to transport staff via a portable tablet computer while the transport staff is engaged in transport of a patient to a care facility to thereby facilitate medical care of the patient;
the patient transport module displaying, via the portable tablet computer, a transport care protocol to the transport staff whereby the transport care protocol sequentially displaying pages of patient care tasks to the transport staff, wherein the patient care tasks are specific to transport of a patient with a predetermined medical condition, and wherein the pages of patient care tasks are automatically displayed to the transport staff within predetermined patient care time periods or assessment categories during the transport of the patient.

12. The method of claim 11, wherein the method comprises the transport care protocol continuously displaying a timeline overview which provides an overview of patient care tasks which are performed in past, present, and future patient care time periods representing different time periods during transport of a patient to a care facility.

13. The method of claim 11, wherein the method further comprises the transport care protocol displaying a countdown timer which displays time remaining in a current patient care time period representing a portion of the total time during patient transport to a care facility and the transport care protocol displaying an elapsed transport time representing total elapsed time in transporting a patient to a care facility.

14. The method of claim 11, wherein the method further comprises the transport care protocol providing multiple patient care time periods of predetermined duration representing time to transport a patient to a care facility and the transport care protocol chronologically presenting patient care tasks to the transport staff which are specific to each time period as each patient care time period begins.

15. The method of claim 14, wherein each patient care time period is associated with predetermined patient care tasks.

16. The method of claim 14, wherein the method further comprises:
the transport care protocol displaying patient care tasks for different patient care time periods or assessment categories in different columns, with a particular column associated with a particular patient care time period or assessment category;
the transport care protocol presenting patient care tasks for a patient care time period or assessment category separately based on types of patient care tasks;
the transport care protocol presenting information and care steps for different types of patient care tasks separately as different display pages within a column; and
the transport care protocol displaying pages within a patient care time period or assessment category are separately as rows within the column.

17. The method of claim 11, wherein the method further comprises:
the transport care protocol displaying a plurality of pages of patient care tasks in an array having multiple columns and multiple rows wherein:
an array column comprises pages of patient care tasks to be performed during a predetermined patient care time period or assessment category during transport of the patient;
rows of pages within a column represent different types of patient care tasks to be performed;
wherein transport staff may scroll vertically through pages of patient care tasks pertaining to a patient care time period or assessment category; and
the transport staff may scroll horizontally through patient care tasks pertaining to different patient care time periods or assessment categories.

18. The method of claim 17, wherein the transport care protocol comprises a home button programmed to return a user to an appropriate location within the transport care protocol based on a current patient care time period or assessment category.

19. The method of claim 11, wherein the method further comprises the patient transport module providing encrypted video communications between the tablet computer and a remote computer and allowing transport staff to select between a front facing camera to capture and display images of the transport staff and a rear facing camera to capture and display images of a patient.

20. The method of claim 11, wherein the method further comprises the patient transport module displaying to transport staff an electronic patient care form, receiving patient information regarding a patient who is being transported from the transport staff into the electronic patient care form, and automatically transmitting patient information to a computer at a receiving care facility to create an electronic patient record.
